(19) United States
(12) Patent Application Publication
(10) Pub. No.: US 2005/0246192 A1
(43) Pub. Date: Nov. 3, 2005

(54) Transportation management system and method for shipment planning optimization

(76) Inventors: Francisco Jauffred, Burlington, MA (US); Kazi Ahmed, Winchester, MA (US); Sal Arminio, Uxbridge, MA (US); Harsh Desai, South Grafton, MA (US); Pervinder Johar, Westboro, MA (US); Russell McGregor, Canterbury (AU); Mark Pluta, Miami Beach, FL (US); Carl Wilson, Norcross, GA (US)

Correspondence Address: HOWREY LLP, C/O IP DOCKETING DEPARTMENT, 2941 FAIRVIEW PARK DR, SUITE 200, FALLS CHURCH, VA, 22042-2924, US

(21) Appl. No.: 11/083,337

(22) Filed: Mar. 18, 2005

Related U.S. Application Data
(60) Provisional application No. 60/553,979, filed on Mar. 18, 2004.

(51) Int. Cl. G06F 17/60

(52) U.S. Cl. 705/1; 705/13; 705/8

(57) ABSTRACT

System and method for planning transportation shipments for delivery and pickup of goods. The system may plan shipments based on such factors as requested goods to be picked up and delivered, while minimizing the cost of the shipments planned. Constraints can be placed on the transportation resources and the goods to be moved that will restrict the possible shipments considered by the planning method. The method may be capable of considering all possible locations through which goods can be moved by shipments. The method may also be capable of quickly solving problems with a large number of potentially varying goods to be transported.

### PRIORITY

This application claims priority to U.S. Provisional Patent Application No. 60/553,979, filed Mar. 18, 2004 and entitled TRANSPORTATION MANAGEMENT AND METHOD FOR SHIPMENT PLANNING OPTIMIZATION. That application is hereby incorporated herein by reference in its entirety.

### BACKGROUND OF THE INVENTION

1. Field of the Invention

The invention relates generally to the planning of transportation shipments to be executed for the movement of goods from origin to destination. More specifically, the invention relates to optimizing such variables as routes, order type, driver type, etc., based on consideration and/or processing of various transportation/shipping-related factors.

2. Related Art

Transportation Management Systems (TMS) have been addressing the problem of shipment planning optimization in one form or another for years. Numerous algorithms and approaches to this class of problems have been proposed. However, each of these approaches suffers certain drawbacks. One notable drawback has been that many systems and methods, due to inherent complexities and other factors, have been unable to consider all desired variables in determining a solution. The present invention seeks to address certain of these and other shortcomings of known solutions.

### SUMMARY OF THE INVENTION

In one aspect, the invention uses a route generation algorithm to solve large-scale consolidation and routing problems. The transportation network optimized by the invention may be formed by pickup locations, consolidation centers (“center-points”) and delivery locations, among others. Typically, a route starts at a pickup location, loads some or all orders at this location and, if the route is multi-stop, may continue to one or more additional pickup/dropoff locations. The final stop may be, for example, a consolidation center or delivery location. Multiple deliveries to delivery locations are allowed in some routes if desired and/or determined to be optimal/preferred. FIG. 1 provides an overview illustration 100 of possible routes from origins (O), potentially through center-points (CP), to destinations (D).

Shipment plans generated by the invention may be used to dispatch transportation resources, e.g., common carriers, private fleets, etc. The shipments may provide information and directions for designated transportation resources to perform the physical transportation of the orders—i.e. the execution of the shipment—among other goals. Such planning may be useful at various levels of a supply chain, between trading partners, or other possible entities. For example, a supplier may utilize various aspect of the invention to schedule delivery of goods from a manufacturer and/or delivery of goods to a retailer, etc. The invention may relate to shipments with respect to a single location, or may be used with respect to a vast network of locations spread across a wide area, depending on a particular implementation.

Decisions to be made may include, but are not limited to:
Which pickup locations to visit in a route and/or in what order
Which location (e.g., destination or center-point) is the final stop
Which orders are assigned to which routes
Which truck types to assign to which routes
What driver types to assign to which routes
How many routes to send to a center-point
The timing—stops, rests, waiting—of each event on a route
When an order should be routed by itself
When an order should be routed together with other orders
Others as desired, depending on a particular problem to be solved

In one aspect of the invention, an effective global (e.g., in the optimization sense) consolidation system is provided that is able to consider some or all of these variables and/or others simultaneously, seeking to optimize a global metric, often total cost or time, or other variables. Various known methods have been proposed that include dividing such a process into sequential stages (e.g., assigning consolidation centers to orders and then performing the routing), often obscuring important consolidation opportunities that might otherwise lower a cost or other relevant variable associated with a solution. Thus, the present invention seeks to provide an improved system and method, the details of various embodiments of which are provided herein.

### BRIEF DESCRIPTION OF THE FIGURES

Additional features and advantages of the present invention will become more fully apparent from a review of the following detailed description of embodiments of the invention, along with the accompanying drawings, in which:

FIG. 1 illustrates an overview of possible routes considered in an embodiment of the present invention;

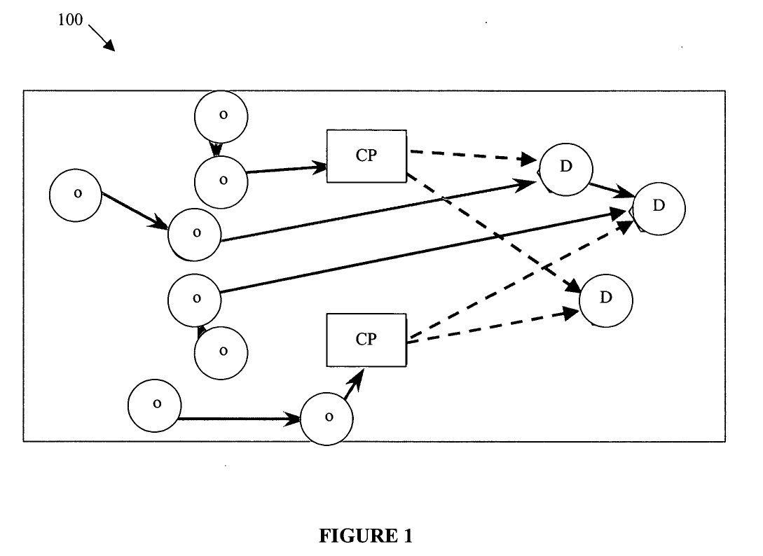

FIG. 2 is a flow diagram illustrating a solution approach in accordance with an embodiment of the present invention;

FIG. 3 is a flow diagram illustrating an embodiment of a method for route generation in accordance with an embodiment of the present invention;

FIG. 4 is a flow diagram illustrating an embodiment of a method for route generation in accordance with an embodiment of the present invention; and

FIG. 5 illustrates an overview of possible routes considered in an embodiment of the present invention.

### DETAILED DESCRIPTION OF EMBODIMENTS OF THE INVENTION

In one embodiment, the invention considers a global approach to solving a shipment-planning problem (also known as consolidation, or route planning problem) based on route generation techniques. This class of problem is widely recognized, and is sometimes called the Vehicle Routing Problem (VRP), which is itself a variation on the Traveling Sales-Person problem (TSP). Specifically, these problems relate to methods for solving problems such as designing transportation routes for vehicles, using such variables as vehicle capacities, required delivery pick-up and/or delivery locations, etc. The routes may be solved with an aim to achieve such goals as minimizing the total cost of the transportation involved in moving the orders, minimizing overall delivery time, or a combination of these or other desired outcomes.

Large optimization problems involving large numbers of variables (in some cases, a million or more) may require specialized solution techniques. In particular, problems in which those variables represent combinations of decisions (e.g., combinations of truck, driver, center-points, etc.) may be especially large, often ranging in the billions of variables or more. Generation methods may be used to trim those variables, such as by looking only for relevant combinations (in one embodiment, routes) that are more likely to lead to some improvement in the solution quality. In one embodiment, the generation method of the invention works by adding new stops to promising routes at each iteration of the process. The process may end when, for example, no more promising routes are generated, when a maximum number of stops per route is achieved, etc.

In addition to route generation, the invention may generate priorities to rely more heavily on certain factors and/or disregard others, to help speed up the solution of the optimization model. In one embodiment, a master optimization engine of the invention is an integer-programming (IP) model. After a generation phase is complete, a set of “lifting inequalities” may be added. This set of lifting inequalities, referred to herein as “cuts,” uses generally recognized methods to discard one or more non-optimal solutions to the problem, often large groups of solutions at a time, potentially greatly expediting the solution process.

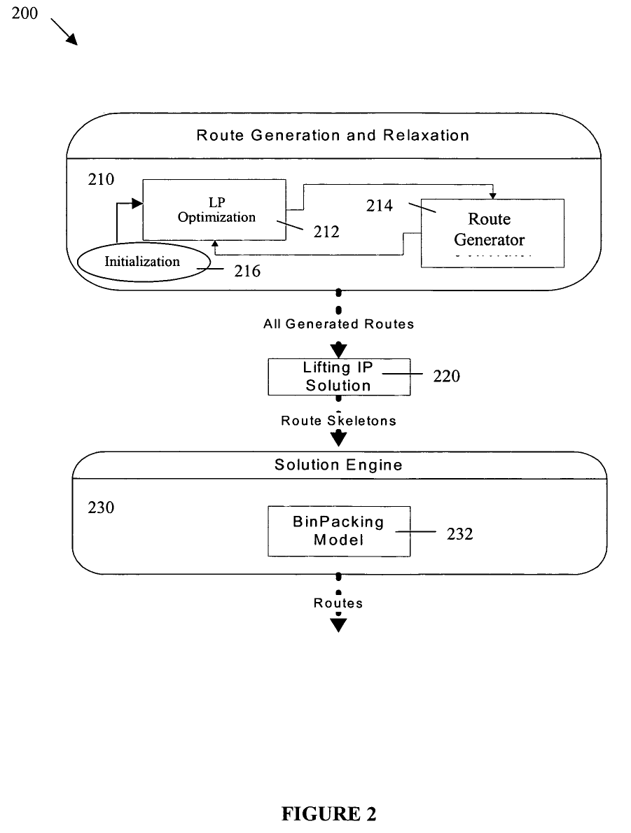

Due to such factors as restrictions in the physical memory, speed and/or processing power (among other qualities) of many computers, the method of the invention may be practiced in phases. In one embodiment, three phases are used. For illustrative purposes, FIG. 2 provides an overview of a three-phase solution approach 200 in accordance with an embodiment of the invention.

FIG. 2 shows a solution approach 200 having a route generation and relaxation phase 210, a lifting solution phase 220 and a bin-packing phase 230. The route generation and relaxation phase 210 includes an LP Optimization portion 212 and a route generator 214. An Initialization portion 216 may provide any needed initialization information. The lifting solution phase 220 may implement a lifting integer programming (IP) solution. Bin-packing phase 230, as shown, may include a bin-packing model 232. Additional details are provided herein.

In one embodiment, such aspects of the invention are implemented purely in software or similar modules, and may be supported on any of a variety of devices, such as on a mainframe or by a stand-alone or networked processor, etc. For example, in a three-phase implementation discussed below, individual phases may be implemented as discrete software modules, embodied in a computer-readable medium. Databases or other record structures may be variously incorporated as well. The items of data considered by an embodiment of the invention may be generated and/or received locally, or may be transmitted over vast distances, such as over a communication network, e.g., the Internet or others.

Additional detail is provided below through a discussion of embodiments of the invention, including exemplary constraints, assumptions, calculations, etc. For example, in one such embodiment, a solution is implemented as follows:
Phase 1: Generation and relaxation. In this phase, the method creates new routes using a relaxed version of a master linear program (described below), i.e., certain requirements may be relaxed or eliminated. Aggregated quantities derived from the orders for Origin-Destination (O-D) pairs may be used instead of individual orders. The invention may generate and optimize routes that finish at center-points. The dual prices obtained by solving the problem defined herein as a linear programming (LP) solution may be used in the generation of direct routes to delivery locations. Routes with multiple deliveries to delivery locations may then be generated in this stage and added to the master linear program.
Phase 2: Lifted solution. After the route generation routine is finished, lifting inequalities may be added to the master linear program, such as to strengthen the relaxation. If time and problem size allow, this stage can be solved as an integer programming model using well-established techniques. An integer programming model is a combinatorial problem that determines optimal values (where the values for the variables are often required to be integers) for multiple variables to maximize an objective function (such as cost) while meeting multiple constraints on those variables. Exemplary constraints are provided below. There are many tools and packages available that can be used to solve a general IP problem. The solution of this stage may be saved as route skeletons. In one embodiment, these route skeletons do not yet have specific orders assigned to them, only a sequence of stops.
Phase 3: Bin-Pack solution. As will be appreciated by one skilled in the art, when a problem is formulated as a bin pack problem, the problem generally becomes one of determining how to put the most objects in the least number of fixed space “bins”. More formally, it may be desirable to find a partition assignment of a set of objects such that a constraint is satisfied or an objective function is minimized (or maximized). There are many variants, such as, 3D, 2D, linear, pack by volume, pack by weight, minimize volume, maximize value, fixed shape objects, etc. In one embodiment, the “bins” are the route skeletons. These route skeletons may be used in a fully detailed model that routes some or all individual orders using their individual characteristics, time windows, travel time, etc.

In various embodiments of the invention, several advantages may be realized as compared with certain known solutions. For example, the present invention may:
Be capable of quickly solving problems of large sizes, e.g., problems with tens of thousands of orders or more, without having to split, or “decompose” the problem into independent, smaller problems. Certain known solution attempts have taken such a decomposition approach to solving large problem sizes, and this has been found to sacrifice solution quality under some circumstances. For example, after such decomposition, the best possible solution has very often been found to be worse than the overall best solution.
Be capable of considering many or all possible locations as options through which an order could be moved on its way from origin to destination (e.g. cross dock locations, pool point locations, etc.). Certain known solutions artificially restrict these possible “center-points” for each order as a way of reducing problem complexity. This simplification, however, has been found to sacrifice solution quality in a manner that the present invention seeks to avoid.
Offer explicit optimization using lane-based rates (e.g., rates that differ based on such factors as the origin and destination of the route to be taken) for route generation. This has been found to improve solution quality versus many known solutions, such as those that make an assumption that the rates to be used are the same regardless of where the routes start and end. In many real-world situations, this is not a correct assumption, and may lead to degraded solution quality.
Offer a unique heuristic method for route generation. This heuristic method seeks to enable faster and better quality solutions over such known solutions as a route generation approach.
Offer an innovative solution formulation where route generation need not be dependent on explicit orders and/or the optimization need not depend on set covering. That is, in one embodiment for example, each order in a problem formulation need not be put on exactly one route. This approach seeks to increase a number of potential solution alternatives that can be examined and/or increase a speed in which they can be examined, versus such known methods as the set covering approach. The Bin-Pack solution is described in greater detail below.
Provide lifting constraints in such a formulation as to obtain near-optimal or optimal solutions (examples provided below). The lifting constraint approach generally is an established method for speeding solution of IP problems by adding additional variables to the solution having the effect of simplifying the structure of the problem.
Provide lifting constraints during route generation (examples provided below).

Additional exemplary details of various embodiments of the present invention will now be provided. In that regard, various variables and parameters associated with following description are as follows:
zᵣ is the fractional number of skeletons needed to cover this route. Solution Output.
x_{od,r} is the fraction of orders from pickup-destination pair od assigned to route r. Solution Output.
φ_{od} is the fraction of orders from pickup-destination pair od using the base-line mode. Solution Output.
p_{od} is the aggregate base-line cost for pickup-destination pair od. Preprocessed input.
h_{od,cp} is the handling cost of pickup-destination pair od assigned to center-point cp. Problem input.
cᵣ is the cost of route r. Calculated during route generation.
V_{od} is the total volume of the pickup-destination pair. Preprocessed input.
W_{od} is the total weight of the pickup-destination pair. Preprocessed input.
TV is the representative volume capacity. Problem input.
TW is the representative weight capacity. Problem input.
δ_{cp,r} is one if route r serves center-point cp, 0 otherwise. Calculated during route generation.
C_{cp} is the loads capacity at the cp. Preprocessed input.
β_{d,r} is one if route r uses driver type d, 0 otherwise. Calculated during route generation.
ND_{d} is the number of drivers of type d available. Problem input.
γ_{t,r} is one if route r uses truck t, 0 otherwise. Calculated during route generation.
Nₜ is the number of trucks of type t available. Problem input.
ω_{od} is the size factor of the origin-destination pair in on route r. Preprocessed input.

$${ω}_{od} = [ \frac{{V}_{od}}{{min}_{o ∈ O ( od )} {V}_{o}} , \frac{{W}_{od}}{{min}_{o ∈ O ( od )} {W}_{o}} ]$$
εᵣ is a proportional factor for route r, about 0.01. Problem parameter.

In one embodiment, the first and second phases of the invention solution process are strategic while the third phase is tactical. For example, the first two modules may merely create routes, and need not consider the specific orders to be assigned. Specifically, they may explore the universe of feasible routes that cover the aggregate demand of the planning problem while disregarding the issues of individual orders meeting their individual target pick up and delivery times. In such an embodiment, the Bin-Pack phase of the present invention may then be utilized to address tactical issues, including the time dimension that may be ignored by the strategic part of the solution engine, among others.

As noted above, in one aspect the present invention may seek to simplify certain factors considered in generating a transportation plan. As an example, certain values may be considered in the aggregate, rather than discretely. In one embodiment, such aggregation may be applied to one or more of: volume and/or weight of orders, center-point capacity, baseline cost, among others. Specifically, in an implementation utilizing three phases as described above, beneficial results have been observed upon applying such aggregations to at least phases 1 and 2. Examples of such aggregations are now provided. Of course, numerous variations on such will be readily apparent to one skilled in the art upon consideration of the present disclosure.

Phase One and Two Order Aggregation

Volume and weight may be aggregated by origin-destination pair for some or all orders in the consolidation run, as follows:

$$\begin{matrix}{V}_{od} = {\sum }_{o ∈ O ( od )} {V}_{o} & ∀ od \\ {W}_{od} = {\sum }_{o ∈ O ( od )} {W}_{o} & ∀ od\end{matrix}$$

Phase One and Two Center-Point Capacity Aggregation

The Center-Point capacities used in the strategic part of the model may be, or may be based on, the aggregated capacities of individual periods. The center-point capacity is a limit that may be set on the volume of orders that can be sent through a particular center-point.

$${C}_{cp} = {\sum }_{p} {C}_{p , cp} \qquad ∀ cp$$

Phase One and Two Baseline Cost Aggregation

An aggregated value of the base-line cost may be used to help bound the dual prices in the linear program. The baseline cost represents the cost of moving an order by itself. The solution seeks to move the order more cheaply by consolidating the order onto routes with other orders.

$${p}_{od} = {\sum }_{o ∈ O ( od )} {p}_{o} \qquad ∀ od$$

In accordance with the present invention, routes may be generated in an iterative way. In a three-phase embodiment, a system of the invention may start in phase 1 with an initial set of one-stop routes to various center-points, if any, and may add new stops to some of these routes as desired, such as at every new iteration. The new routes are then represented in the master linear program by adding new variables and new constraints. The process can continue until some predefined maximum number of iterations has been reached, until no new routes are found, or until another predetermined condition has been achieved.

LP Modeling—Generation LP. In a three-phase embodiment, as described above, the first phase may include an LP model. This LP model defines the transportation problem that is to be solved in mathematical terms. This formulation in intended to ensure that the solutions obtained during each iteration are feasible solutions in that they take into account all the necessary business rules. These business rules may be described by any of a variety of constraints. Exemplary constraints and other features, any or all of which may be used in any particular implementation, among others, are described below. Throughout this disclosure, parenthetical notations may be included with the exemplary features as a source of additional information.

Objective Function

Depending on a particular embodiment or implementation, an objective or objectives of this phase of the invention may be to minimize the cost of routing the aggregated order volume, the sum of the cost when routing orders by themselves, the cost when handling orders at each center point, and/or the cost when routing orders together, among other possibilities.

$$min {\sum }_{od} {p}_{od} {φ}_{od} + {\sum }_{od} {\sum }_{r} {h}_{od , r} {x}_{od , r} + {\sum }_{r} {c}_{r} {z}_{r}$$

Volume and Weight Constraints

These represent limits that may be applied to ensure that the total volume and weight of a shipment do not exceed a maximum capacity.

$$\begin{matrix}{\sum }_{od ∈ OD ( r )} {V}_{od} {x}_{od , r} \leq TV {z}_{r} & ∀ r \\ {\sum }_{od ∈ OD ( r )} {W}_{od} {x}_{od , r} \leq TW {z}_{r} & ∀ r\end{matrix}$$

Center-Point Capacity Constraints

These represent limits that may be applied to ensure that the number of routes to a center-point does not exceed the capacity of the center-point.

$${\sum }_{r} {δ}_{cp , r} {z}_{r} \leq {C}_{cp} \qquad ∀ cp$$

Truck Availability Constraints

These represent limits that may be applied to ensure that the number of routes generated does not exceed the number of available truck units.

$${\sum }_{r} {γ}_{t , r} {z}_{r} \leq N {T}_{t} \qquad ∀ t in truck types .$$

Driver Availability Constraints

These represent limits that may be applied to ensure that the number of routes generated does not exceed the number of available driver units.

$${\sum }_{r} {β}_{d , r} {z}_{r} \leq N {D}_{d} \qquad ∀ d in driver types .$$

Location tie constraints (an implicit constraint that may be applied to ensure that locations are not visited more than once)

$${\sum }_{od ∈ OD ( r , l )} {ω}_{od} {x}_{od , r} \geq {ɛ}_{r} {z}_{r} \qquad ∀ r , l \text{:} l ∈ stops ( r )$$

Cover constraints (may be applied to ensure that the aggregate order volume is completely placed on some combination of routes)

$${φ}_{od} + {\sum }_{r ∈ R ( od )} {x}_{od , r} = 1$$

Variable Domain
zr≧0 ∀r
x_{od,r}≧0, x_{od,r} ε R, ∀r, od ε OD(r)
φ_{od}≧0 ∀od

Once appropriate constraints are determined, a route generation algorithm of the present invention may be applied. In one embodiment, the following procedures are utilized in solving the model established in Phase 1, as described above. For illustrative purposes, implementations involving problems both of 1) a center-point route generation and 2) direct routes and multiple deliveries to destinations, are described herein.

Center-Point Route Generation

Initialization: In one embodiment, center-point route generations begin with creating a set of all feasible combinations of pickup locations to center-point legs, truck types and drivers. This set may represent all feasible one-stop routes, and is referred to herein as G₀, with r₀ representing the number of routes in the set G₀. Variables zᵣ r=0, . . . ,r₀−1 may then be assigned to represent each one of these routes in the master linear program, with a generation counter being initialized to g=0 and a route set to G=G₀. Initialization portion 216 in FIG. 2 is an exemplary implementation.

Re-Optimization: Solve the relaxed version of the master linear program and obtain the LP solution values for \tilde{z}ᵣ r=0, . . . ,rₖ. LP Optimization portion 212 in FIG. 2 is an exemplary implementation.

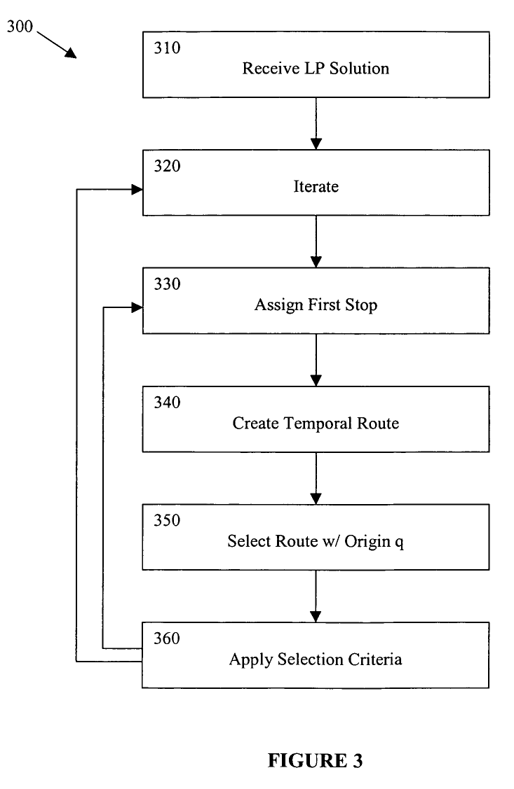

Generation step (k iterations): Route Generator 214 in FIG. 2 is an exemplary implementation. Let the generation counter be g=k. In one embodiment, a generation k+1 is achieved in accordance with the following method 300 illustrated in FIG. 3:
1. LP Solution (310): Retrieve the incumbent LP solution for all previous iterations \tilde{z}ᵣ r=0, . . . ,rₖ; initialize the new generation route set Gₖ=Ø.
2. Iterate (320): Begin iterating over all r=rₖ, . . . ,rₖ−1 such that \tilde{z}ᵣ>0.
3. First Stop (330): Let sᵣ be the first stop of route r. Let Qᵣ the set of pickup locations defined by Qᵣ={q|(q,sᵣ)ε N} where N is the set of all valid network legs. Iterate over all q ε Qᵣ. Iterate by increasing distance (q,sᵣ).
4. Temporal route (340): Create the temporal route \hat{r} by appending q as the first stop of route r. Find the cost c_{\hat{r}} of the temporal route using its new length and the applicable lane rate.
5. Selection Route (350): From the set of routes r′ such that 0≦r′≦rₖ, \tilde{z}_{r′}>0 and the first stop of r′ is q, find r* where r*=arg max{c_{r′}(Ceil(\tilde{z}_{r′})−\tilde{z}_{r′})−c_{\hat{r}}(Ceil(\tilde{z}_{r′}\tilde{z}ᵣ)−\tilde{z}_{r′}−\tilde{z}ᵣ)}. This is the route with origin in q that will be used in the selection criterion. Calculate the pseudo-value: z_{\hat{r}}=1−Ceil(\tilde{z}_{r*}+\tilde{z}ᵣ)+\tilde{z}_{r*}+\tilde{z}ᵣ.
6. Selection Criterion (360): If c_{\hat{r}}(Ceil(\overline{z}_{\hat{r}})−\overline{z}_{\hat{r}})≦cᵣ(Ceil(\tilde{z}ᵣ)−\tilde{z}ᵣ)+c_{r*}(Ceil(\tilde{z}_{r*})−\tilde{z}_{r*}), then the new route is a candidate for optimization. Make Gₖ=Gₖ ∪ {\hat{r}} and loop back to 2. If the criterion is not met, reject route \hat{r} and continue the loop on 3.

Generation Termination Criterion: If the set Gₖ is empty, no more routes will be found and the generation method may be halted. Otherwise the algorithm should proceed through another iteration of route generation.

Generation of Destination Direct Routes and Multiple Deliveries to Destinations

The invention disclosed herein can be used to solve a transportation routing problem for many different transportation networks. In addition to the above-described Centerpoint (CP) route types, other route types may of course be addressed. For purposes of further illustration, a discussion will now be provided for an embodiment that may be used to solve a network having routes defined by the following terminology:
“V-V-D”—pickup at one or more origins (V) and delivery at one destination (D).
“V-V-D-D”—pickup at one or more origins (V) and delivery at one or more destinations (D).

This section describes an embodiment to solve such networks, and illustrates the flexibility of the invention as a utility and approach to transportation networks in general.

Candidate Origin-Destination pairs in a route: For illustration, a V-V-D-D route is assumed to have one or more pick-ups followed by one or more deliveries. In one embodiment, the Origin-Destination (OD) pairs that are candidates to be considered as part of the route are required to conform to the following conditions:
Only OD pairs that have both their pick-up location and their delivery location as part of the route.
Only OD pairs that conform to First-In-Last-Out (“FILO”) are considered as candidates in the route. For example, it may be required that any two OD pairs conform to FILO only if their pick-up and delivery sequences meet the condition:
   sequence(PickUp(odᵢ))≦sequence(PickUp(odⱼ)) [symbol] sequence(Delivery(odᵢ))≧sequence(Delivery(odᵢ))

Initialization: After the CP route generation has finished, dual values of the cover constraints may be obtained. These are referred to herein as q_{od}, and they represent the cost in the relaxed model of delivering all the orders in the origin destination pair od. The route set is initialized as H=Ø.

Acceptance criterion rule: For every route generated at any step of this algorithm, the route r may be accepted and added to the route set if it meets the criterion:

$${c}_{r} max ( \frac{{\sum }_{od ∈ \{ od candidates in r \}} {V}_{od}}{T {V}_{r}} , \frac{{\sum }_{od ∈ \{ od candidates in r \}} {W}_{od}}{T {W}_{r}} ) \leq ( 1 + η ) {\sum }_{od ∈ \{ od candidates in r \}} {q}_{od}$$

where η is a fixed positive parameter that will set a tolerance on the selection criterion.

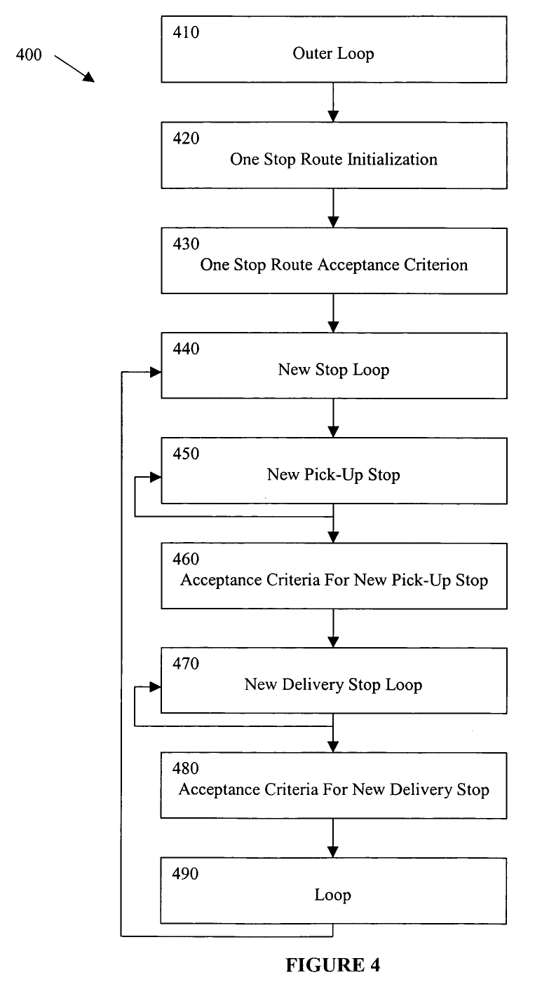

In one embodiment, the generation step may be performed in accordance with the following method 400 illustrated in FIG. 4:
1. Outer loop (410): For all the origin-destination pairs od, iterate by decreasing value of q_{od}.
2. One stop route initialization (420): Create the one stop route r^{1,1} that starts at the pickup location of pair od and ends at the corresponding destination.
3. One stop route acceptance criterion (430): If the acceptance criterion for the single stop route is met, add the route to the route set H=H ∪ {r^{1,1}}.
4. New stop loop (440): At any iteration of this loop, the route r^{i,j} has i pick-up stops and j delivery stops.
5. New pick-up stop (450): For all the pickup locations that are not along route r^{i,j}, loop by increasing distance from the current last pick-up. Create the new route r^{i+1,j} by inserting the new pickup stop after the last pick-up and before the first delivery. If it meets the feasibility criterion (time-windows, location, etc.), continue to 6. Otherwise, loop 5 again.
6. Acceptance criteria for new pick-up stop (460): If there is an OD pair with non-negative volume and weight from the last pick-up to the first delivery of this route, use the acceptance criterion rule. If it meets the criterion: H=H ∪ {r^{i+1,j}}.
7. New delivery stop loop (470): For all the destinations that are not part of route r^{i+1,j}, loop by increasing distance from the current first delivery. Create the new route r^{i+1,j+1} by inserting the new destination stop after the last pick-up and before the first delivery. If it meets the feasibility criterion (time-windows, truck-location, etc.), continue to 8. Otherwise, loop on 7 again.
8. Acceptance criteria for new delivery stop (480): If there is an OD pair with non-negative volume and weight from the last pick-up to the first delivery of this route, use the acceptance criterion rule. If it meets the criterion: H=H ∪ {r^{i+1,j+1}}. Loop on 5.
9. Loop on 4 (490).

Following completion of the generation phase 1, in accordance with one embodiment of the present invention, phase 2 may involve the addition of lifting constraints, as described below. Route skeletons to be passed to the Bin-Pack model may be selected during this phase. A formulation for this phase in accordance with one embodiment of the invention is as follows:
Lifting Constraints

$${\sum }_{r ∈ R ( l )} {z}_{r} \geq {λ}_{l} \qquad ∀ l ∈ VendorLocation ,$$

where the lower bound λₗ is minimum number of routes needed to serve this location.

$${λ}_{l} = max ( ⌈ \frac{{\sum }_{o ∈ O ( l )} {V}_{o}}{{max}_{r ∈ R ( l )} T {V}_{r}} ⌉ , ⌈ \frac{{\sum }_{o ∈ O ( l )} {W}_{o}}{{max}_{r ∈ R ( l )} T {W}_{r}} ⌉ )$$

Certain routes may then be utilized in subsequent phases of the invention. For example, the routes with non-zero solution may be passed as route-skeletons to the Bin-Pack solver. In one embodiment, the Bin-Pack solver assigns individual orders to route skeletons. It may also calculate optimal arrival and departure times to the pickup locations. Orders that do not fit one of the candidate routes at their location may be assigned to a route on their own, where the cost may be assumed to be the baseline cost. As described in the previous phases, in one embodiment, the route skeletons passed to Bin-Pack are all non-negative solutions of the master problem that has been “lifted” (using the lifting constraint approach) as described in phase 2, along with all non-negative solutions of all the phase 1 route generation LPs for V-V-CP, V-V-D and V-V-D-D.

To illustrate an implementation of the Bin-Pack solution in accordance with an embodiment of the present invention, a number of potential constraints, exceptions, functions, etc., that may be used are hereinafter provided. One skilled in the art, however, will appreciate that any or all of the following or other features may be applied in any particular implementation of the invention.

Various variables and parameters associated with the following description are as follows:

Variable Domain
z_{r,t} ε {0,1} ∀r
x_{o,r} ε {0,1} ∀o, r:o ε O(r)
ltlₒ ε {0,1} ∀o:o ε Orders
0≦ta_{s,r}≦\overline{T} ∀r, s:s ε stops(r)
0≦td_{s,r}≦\overline{T} ∀r, s:s ε stops(r)
u_{p,s,r} ε {0,1} ∀r, s ε stops(r), p ε P(s, r)
v_{p,s,r} ε {0,1} ∀r, s ε stops(r), p ε P(s, r)
γ_{q,r} ε {0,1} ∀r, ∀q ε {Pr oduct classes}
Variable and Parameter Definition

z_{r,t} is one if route r is selected using trailer type t. 0 otherwise. Solution Output.

x_{o,r} is one if order o is transported in route r. Solution Output.

ltlₒ is one if order o is sent by itself. 0 otherwise. Solution Output.

u_{p,s,r} is one if route r reaches stop s at period p. Solution Output.

v_{p,s,r} is one if route r leaves stop s at period p. Solution Output.

γ_{q,r} is one if route r carries product class q. Solution Output.

ta_{s,r} is the arrival time of route r to stop s. Solution Output.

td_{s,r} is the departure time of route r to stop s. Solution Output.

ω is a positive constant. Problem parameter.

τ_{i,j} is the travel time between locations i and j. Problem input.

WTₛ is the maximum idle time at stop s. Problem parameter.

\overline{T} is the length of the planning horizon. Problem parameter.

aₒ is the Pick-Up start time for order o. Problem input.

bₒ is the Pick-Up end time for order o. Problem input.

a′ₒ is the Delivery start time for order o. Problem input.

b′ₒ is the Delivery end time for order o. Problem input.

α_{p,r,s} is the location open time for stop s in route r during period p. Problem input.

β_{p,r,s} is the location close time for stop s in route r during period p. Problem input.

C_{p,cp} is the center-point cp capacity in planning period p. Problem input.

MC_{p,cp} is the minimum number of routes that should get to center-point cp in planning period p. Problem Input.

TVₜ is the volume capacity of equipment t. Problem Input.

TWₜ is the weight capacity of equipment t. Problem Input.

θₒ is the loading time of order o. Problem input.

θₒ is the unloading time of order o. Problem Input.

pₒ is the penalty (baseline cost) of order o. Problem input.

h_{o,r} is the total handling cost of processing order o at the center-point where route r ends.

If route r doesn't deliver order o at a center-point, the handling cost is zero. Problem input.

δ_{cp,r} is one if route r finishes at center-point cp. Generated Input.

$${n}_{q , r} = Card ( \{ Product class q \} ⋂ \{ orders eligible in route r \} )$$

number of orders of product class q, that can travel in route r. Generated Input.

HT_{o,cp} handling time of order o at center-point cp. Problem Input.

\overline{τ}_{o,cp} travel time of order o from center-point cp to its final destination. Problem Input.

FLTₛ fixed loading time at stop s. Problem Input.

FUTₛ fixed unloading time at stop s. Problem Input.

FHT_{cp} fixed handling time at center-point cp. Problem Input.

mᵣ number of stops in route r. Generated Input.

$${χ}_{r , s} = {loading\_rate}_{s} \cdot min [ {V}_{r} , {\sum }_{o ∈ Orders ( s )} {v}_{o} ]$$

average dwelling time of route r at stop s. Problem Input.

DT Driver allowed duty time. Problem Input.

RT Driver allowed resting time. Problem Input.

P(s, r) is the set of applicable time periods to stop s in route r. It includes the periods between the earliest pick-up of the orders eligible to go in that route to the latest pick-up.

εᵤ value of the perturbation for the u variables, default value 0.0001. Problem Input.

εᵥ value of the perturbation for the v variables, default value 0.0001. Problem Input.

Bin-Pack Route Preprocessing

In one embodiment, it may be desirable that, for example, routes that are more expensive than the sum of the cost of sending every possible order that could potentially travel on the route by itself, not be passed to the Bin-Pack model. That is, if it is possible to assign orders to a route in such a way that the cost of having sent those orders by themselves is more than the cost of the route, it may be desired that the route not be considered in the bin-pack solution. Therefore, the condition to be satisfied may be defined by:

$${\sum }_{o ∈ \{ \begin{matrix}orders that can \\ travel in route r\end{matrix} \}} {p}_{o} \geq {c}_{r}$$

In one embodiment, the bin-pack problem is now used to compute the solution to the transportation problem by using the following formulation. This formulation takes into account the required business rules, and each exemplary constraint below models one of those business constraints.

Bin-Pack Objective Function

Depending on a particular embodiment or implementation, an objective or objectives of this phase of the invention may be to minimize the cost of routing orders while simultaneously minimizing the duration of each route and/or spreading out the arrival times of routes at each facility, among other possibilities. In one embodiment, the cost routing the orders may be defined as the sum of the cost when routing orders by themselves (baseline), the cost when handling an order at the center point, and the cost of each route when orders are routed together.

$$min {\sum }_{o ∈ Orders} {p}_{o} l t {l}_{o} + {\sum }_{o ∈ Orders} {\sum }_{r ∈ R ( o )} {h}_{o , r} {x}_{o , r} + {\sum }_{r} {\sum }_{t ∈ Trucks ( r )} {c}_{r , t} {z}_{r , t} + Ω {\sum }_{r} {\sum }_{s ∈ stops ( r )} t {a}_{s , r} + {ɛ}_{u} {\sum }_{r} {\sum }_{s ∈ stops ( r )} {\sum }_{p ∈ P ( r , s )} p {u}_{p , s , r} + {ɛ}_{v} {\sum }_{r} {\sum }_{s ∈ stops ( r )} {\sum }_{p ∈ P ( r , s )} p {v}_{p , s , r}$$

Route-Vehicle assignment (each vehicle can only be assigned to one route)

$${\sum }_{t ∈ Trucks ( r )} {z}_{r , t} \leq 1 \qquad ∀ r$$

Volume and Weight Constraints

$$\begin{matrix}{\sum }_{o ∈ O ( r )} {V}_{o} {x}_{o , r} \leq {\sum }_{t ∈ Trucks ( r )} T {V}_{t} {z}_{r , t} & & ∀ r \\ {\sum }_{o ∈ O ( r )} {W}_{o} {x}_{o , r} \leq {\sum }_{t ∈ Trucks ( r )} T {W}_{t} {z}_{r , t} & & ∀ r\end{matrix}$$

Center-Point Capacity Constraints

$${MC}_{p , cp} \leq {\sum }_{r} {δ}_{cp , r} {u}_{p , cp , r} \leq {C}_{p , cp} \qquad ∀ cp , p$$

Truck Availability Constraint

$${\sum }_{r} {z}_{r , t} \leq {NT}_{t} \qquad ∀ t in truck types$$

Driver Availability Constraints

$${\sum }_{r} {\sum }_{t ∈ Trucks ( r )} {β}_{d , r} {z}_{r , t} \leq {ND}_{d} \qquad ∀ d in driver types .$$

Location-tie constraints (an implicit modeling constraint that may be applied to ensure that the model does not inadvertently assign more routes to trucks at a location than it has assigned to orders at that location)

$${\sum }_{o ∈ O ( r , l )} {x}_{o , r} \geq {\sum }_{t ∈ Trucks ( r )} {z}_{r , t} \qquad ∀ r , l \text{:} l ∈ stops ( r )$$

Bin-Pack Lifting (a solution strategy that may be intended to speed the solution by simplifying the solution space)

$$l t {l}_{o} + {\sum }_{r ∈ \{ \begin{matrix}routes that stop at \\ the location of order o\end{matrix} \}} {\sum }_{t ∈ Trucks ( r )} {z}_{r , t} \geq 1 \qquad ∀ o ∈ Orders$$

Bin-Pack Facet Lifting constraints (a variation on the lifting constraint solution strategy that may be intended to speed the solution by simplifying the solution space)

$${x}_{o , r} \leq {\sum }_{t ∈ trucks ( r )} {z}_{r , t} \qquad ∀ o , r ∈ R ( o )$$

Order cover constraints (all orders must be on one route in the solution)

$$l t {l}_{o} + {\sum }_{r ∈ R ( o )} {x}_{o , r} = 1 \qquad ∀ o ∈ Orders$$

Loading time constraints (time to load orders, where order overlapping not enforced)

$$t {a}_{s , r} + {FLT}_{s} {\sum }_{t ∈ Trucks ( r )} {z}_{r , t} + {\sum }_{o ∈ O ( r , s )} {θ}_{o} {x}_{o , r} \leq t {d}_{s , r} \qquad ∀ r , s \text{:} s ∈ stops ( r )$$

Loading time constraints (time to load orders, where order overlapping enforced)

$$t {a}_{s , r} + {FLT}_{s} {\sum }_{t ∈ Trucks ( r )} {z}_{r , t} + {\sum }_{o ∈ O ( r , s )} {θ}_{o} {x}_{o , r} = t {d}_{s , r} \qquad ∀ r , s \text{:} s ∈ stops ( r )$$

Travel time constraints (time to travel between stops on the route)

$$t {d}_{s , r} + {τ}_{s , s + 1} {\sum }_{t ∈ Trucks ( r )} {z}_{r , t} \leq t {a}_{s + 1 , r} \qquad ∀ r , s \text{:} s ∈ stops ( r )$$

Idle time while loading (first stop only, use only if order overlapping is not enforced)

$$t {d}_{0 , r} - t {a}_{0 , r} - {FLT}_{s} {\sum }_{t ∈ Trucks ( r )} {z}_{r , t} - {\sum }_{o ∈ O ( r , s )} {θ}_{o} {x}_{o , r} \leq W {T}_{0} {\sum }_{t ∈ Trucks ( r )} {z}_{r , t} + \overline{T} ( 1 - {\sum }_{t ∈ Trucks ( r )} {z}_{r , t} )$$

$$∀ r$$

Waiting time before a stop and idle time before a pick-up (may be used to take into account the case where the travel time between stops is less than the elapsed time between the open hours (time) of each stop)

$$t {d}_{s + 1 , r} - t {d}_{s , r} - {τ}_{s , s + 1} {\sum }_{t ∈ Trucks ( r )} {z}_{r , t} - {FLT}_{s} {\sum }_{t ∈ Trucks ( r )} {z}_{r , t} - {\sum }_{o ∈ O ( r , s + 1 )} {θ}_{o} {x}_{o , r} \leq W {T}_{s + 1} {\sum }_{t ∈ Trucks ( r )} {z}_{r , t} + \overline{T} ( 1 - {\sum }_{t ∈ Trucks ( r )} {z}_{r , t} )$$

$$∀ r , s \text{:} s ∈ stops ( r )$$

Waiting time before a Center-Point (may be used to take into account the time waiting for a CP to open)

$$t {a}_{cp , r} - t {d}_{\hat{s} , r} - {τ}_{\hat{s} , cp} {\sum }_{t ∈ Trucks ( r )} {z}_{r , t} \leq W {T}_{cp} {\sum }_{t ∈ Trucks ( r )} {z}_{r , t} + \overline{T} ( 1 - {\sum }_{t ∈ Trucks ( r )} {z}_{r , t} )$$

$$∀ r , \hat{s} is the stop before the cp$$

Unloading time constraints (v-v-d-d routes only) (time to unload)

$$t {a}_{s , r} + {FUT}_{s} {\sum }_{t ∈ Trucks ( r )} {z}_{r , t} + {\sum }_{o ∈ O ( r , s )} {ϑ}_{o} {x}_{o , r} \leq t {d}_{s , r} \qquad ∀ r , s \text{:} s ∈ stops ( r )$$

Waiting time before a stop and idle time before a delivery (v-v-d-d routes only)

$$t {d}_{s + 1 , r} - t {d}_{s , r} - {τ}_{s , s + 1} {\sum }_{t ∈ Trucks ( r )} {z}_{r , t} - {FUT}_{s} {\sum }_{t ∈ Trucks ( r )} {z}_{r , t} - {\sum }_{o ∈ O ( r , s + 1 )} {ϑ}_{o} {x}_{o , r} \leq W {T}_{s + 1} {\sum }_{t ∈ Trucks ( r )} {z}_{r , t} + \overline{T} ( 1 - {\sum }_{t ∈ Trucks ( r )} {z}_{r , t} )$$

$$∀ r , s \text{:} s ∈ stops ( r )$$

Pick-Up start time constraint (cannot pick up before this time)
td_{s,r}≧(aₒ+θₒ)x_{o,r} ∀r, s:s ε stops(r) o ε Orders(s)

Pick-Up end time constraint (must pick up before this time)
ta_{s,r}≦bₒx_{o,r}+\overline{T}(1−x_{o,r}) ∀r, s:s ε stops(r) o ε Orders(s)

Delivery start time constraint (cannot deliver before this time)
(aᵥ+θᵥ)x_{o,r}≦td_{s,r} ∀r, s:s ε stops(r) o ε Orders(s)

Delivery end time constraint (must deliver before this time)
ta_{s*,r}≦b′ₒ x_{o,r}+\overline{T}(1−x_{o,r}) ∀r, s′=LastStop(r) o ε Orders(s′)

Delivery time end constraint at a center-point (must deliver at CP before this time)

$$t {a}_{cp , r} \leq - {FHT}_{cp} {\sum }_{t ∈ Trucks ( r )} {z}_{r , t} - ( {b}_{o}^{′} - {HT}_{o , cp} - {\overline{τ}}_{o , cp} ) {x}_{o , r} + \overline{T} ( 1 - {x}_{o , r} )$$

$$∀ o , ∀ cp , ∀ r ∈ R ( o ) \text{:} r arrives to cp$$

Stop-Time arrival period cover (cannot exceed trailer unit capacity during the arrival period)

$${\sum }_{p ∈ P ( s , r )} {u}_{p , s , r} = {\sum }_{t ∈ Trucks ( r )} {z}_{r , t} \qquad ∀ r , s ∈ stops ( r )$$

Stop-Time departure period cover (cannot exceed trailer unit capacity during the delivery period)

$${\sum }_{p ∈ P ( s , r )} {v}_{p , s , r} = {\sum }_{t ∈ Trucks ( r )} {z}_{r , t} \qquad ∀ r , s ∈ stops ( r )$$

Stop arrival time window (must arrive within window)
α_{p,s,r}u_{p,r,s}≦ta_{s,r}≦β_{p,s,r}u_{p,r,s}+\overline{T}(1−u_{p,r,s}) ∀r, s ε stops(r) p ε P(s, r)

Stop departure time window (must depart within window)
α_{p,s,r}v_{p,r,s}≦td_{s,r}≦β_{p,s,r}v_{p r,s}+\overline{T}(1−v_{p,r,s}) ∀r,s ε stops(r) p ε P(s, r)

Duty Time Constraint (route cannot violate the driver's duty time allowance)

$$t {d}_{last\_stop , r} - t {a}_{first\_stop , r} \geq {\sum }_{s ∈ \{ Stops in route r \}} {τ}_{s , s + 1} + {m}_{r} χ + R T floor ( [ \frac{\begin{matrix}{\sum }_{s ∈ ( Stops in route r \}} {τ}_{s , s + 1} + {m}_{r} χ - \\ ( {\sum }_{s ∈ \{ Stops in route r \}} {τ}_{s , s + 1} + {m}_{r} χ ) mod DT\end{matrix}}{DT} ] )$$

$$∀ r$$

Product class in a route (may be used to ensure that there are not more orders of a specific product class than are feasible for each route)

$${\sum }_{{o ∈ \{ Product class q \} ⋂}_{\{ {orders eligible}_{in route r} \}}} {x}_{o , r} \leq {n}_{q , r} {γ}_{q , r} \qquad ∀ r , ∀ q$$

Order to order exceptions (incompatible product classes)

For all incompatible pairs of product classes:
γ_{q}_{ᵢ}_{,r}+γ_{q}_{ⱼ}_{,r}≦1 ∀r, qᵢ and qⱼ incompatible product clases.
Order to Route Exception

Note: Order to route exception may include: order to center-point exception, order to truck exception and/or order to driver exception, among others. In one embodiment, these exceptions are handled by not generating the variable x_{o,r} that may assign that order to that route; otherwise, the following constraint may be used:
x_{o,r}=0.
Truck to Driver Exception

This constraint need not be modeled explicitly. During route generation it may be checked that no route is created that has a driver type incompatible with the truck type.

Truck to Location Exception

This constraint need not be modeled explicitly. During route generation it may be checked that no route is created that visits a location that is incompatible with the truck type.

Order Forced Through a Particular CP

Note: In one embodiment, this constraint is handled by not generating x_{o,r} for a route that will visit a center-point different from the one this order should be routed through; otherwise, the following constraint may be used:

$${\sum }_{r ∈ \{ routes that don ' t visit the assigned CP \}} {x}_{o , r} = 0$$

Objective Function Perturbation

In order to strengthen the LP relaxation of the Bin-Pack, it may be desirable to perturb the objective function of repeated routes. Repeated routes may be defined as those that have the same stops, the same time windows and the same set of potential orders, among other potential definitions. In one embodiment, the cost of the repeated routes are perturbed by adding a small amount to the handling cost and transit cost of each one of the copies.

The following pseudo code provides an example:

For all routes r:

For all copies i of route r:

Transit_cost_r_i:=
Transit_cost_r_i + i * transit_perturb_value
For all orders o that can travel in route r

Handling_cost_o_r_i:=
Handling_cost_o_r_i + i *

handling_perturb_value

Next o

Next i

Next r

Multi-Temp Bin-Pack

The following is an additional set of constraints that may be added to the Bin-Pack when it is desired that temperature storage requirements are part of the optimization process. An associated variable domain and variable definitions are also provided. In order to model temperatures in the trailer, it is may be desirable to group the orders by temperature class, stop and route. Again, like other such lists of constraints, definitions, etc. herein, the following are by way of example only, as one skilled in the art would readily envision much variation upon review of the present disclosure.

In one embodiment, the sets are defined as follows:
T(r, s, temp(i))={orders eligible in route r at stop s of temperature temp(i)}
Multi-Temp Variable Domain
ε_{θ,o,r} ε {0,1} ∀r, θ ε {Compartments in r}, o ε {Orders in r}
y_{r,s,temp(i)} ε {0,1} ∀r, s ε stops(r), ∀temp(i)
Multi-Temp Variable Definition

ε_{θ,o,r} is 1 if order o travels in route r in multi-temp compartment 0. Solution Output.

y_{r,s,temp(i)} is 1 if route r leaves stop s at temperature temp(i), 0 otherwise. Solution Output.

Nᵣ Upper bound on the number of orders in the route (could be equal to the total number of orders). Parameter.

kₒ is the size of the order in the multi-temp compartment (usually in pallets). Problem Input.

K_{θ,r} is the capacity of multi-temp compartment p in route r (usually in pallets). Problem Input.

NK is the upper bound in the number of multi-temp compartments in a route. Problem Input.
Multi-Temp Compartment Assignment

$${\sum }_{θ ∈ \{ Compartments in r \}} {ɛ}_{θ , o , r} = {x}_{o , r} \qquad ∀ r , o ∈ \{ Orders eligible in route r \}$$

Multi-Temp Compartment Capacity

$${\sum }_{o ∈ \{ Orders eligeble in route r \}} {k}_{o} {ɛ}_{θ , o , r} \leq {K}_{θ , r} \qquad ∀ r , θ ∈ \{ Compartments in r \}$$

Multi-Temp Compartment Compatibility

$$\begin{matrix}{N}_{r} N K ( 1 - {ɛ}_{θ , o , r} ) \geq {\sum }_{{{o}^{′} ∈ \{ Orders eligeble in route r \}}_{{o}^{′} \neq o }} {\sum }_{{{θ}^{′} ∈ \{ Compartments in r \}}_{{θ}^{′} \neq θ }} {ɛ}_{{θ}^{′} , {o}^{′} , r} \\ ∀ r , o ∈ \{ Orders eligeble in route r \} , θ ∈ \{ Compartments in r \}\end{matrix}$$

Multi-Temp FILO

$$\begin{matrix}{N}_{r} ( 1 - {y}_{r , s , temp ( i )} ) \geq {\sum }_{{s}^{′} > s} {\sum }_{temp ( k ) < temp ( i )} {\sum }_{o ∈ T ( r , {s}^{′} , temp ( k ) )} {x}_{o , r} \\ ∀ r , s ∈ stops ( r ) , ∀ temp ( i )\end{matrix}$$

Multi-Temp FILO-2

$$\begin{matrix}{N}_{r} {\sum }_{temp ( k ) \geq temp ( i )} {y}_{r , s , temp ( k )} \geq {\sum }_{o ∈ T ( r , s , temp ( i ) )} {x}_{o , r} \\ ∀ r , s ∈ stops ( r ) , ∀ temp ( i )\end{matrix}$$

Multi-Temp Temperature Cover

$${\sum }_{temp ( i )} {y}_{r , s , temp ( i )} = {\sum }_{t ∈ Trucks ( r )} {z}_{r , t} \qquad ∀ r , s ∈ stops ( r )$$

Bi-Temp Bin-Pack

For purposes of still further illustration, the following is an additional set of constraints that may be added to Bin-Pack in order to model Bi-Temperature trailers. It is typical for there to be only two compartments on a Bi-Temperature trailer, one in the front and the other in the back of the trailer, with the front being colder than the back. To enforce FILO, colder orders are commonly picked-up first. Given that there are a limited number of positions in which the wall separating the compartments can be set, it is desirable to model the configurations of the trailer. The sets of low temperature and high temperature orders may be defined at each stop of the route.
Low(r, s)={orders eligible in route r at stop s that should go in the front compartment}
High(r, s)={orders eligible in route r at stop s that should go in the back compartment}
Bi-Temp Variable Definition

y_{r,s} is 1 if route r leaves stop s on high temperature, 0 otherwise.

η_{j,r} is one if the wall in the trailer is set to configuration j, 0 otherwise.

kₒ is the size of the order o, usually in pallets.

LK_{j,r} is the capacity of the low temperature compartment (front compartment) for configuration j in route r, usually in pallets.

HK_{j,r} is the capacity of the high temperature compartment (back compartment) for configuration j in route r, usually in pallets.
Bi-Temp FILO

$${N}_{r} {y}_{r , s} \geq {\sum }_{o ∈ High ( r , s )} {x}_{o , r} \qquad ∀ r , s ∈ stops ( r )$$

Bi-Temp FILO-2

$${N}_{r} ( 1 - {y}_{r , s} ) \geq {\sum }_{{s}^{′} > s} {\sum }_{o ∈ Low ( r , s )} {x}_{o , r} \qquad ∀ r , s ∈ stops ( r )$$

Bi-Temp Compartment Capacity

$$\begin{matrix}{\sum }_{s ∈ stops ( r )} {\sum }_{o ∈ Low ( r , s )} {k}_{o} {x}_{o , r} \leq {\sum }_{j ∈ Config ( r )} L {K}_{j , r} {η}_{j , r} & & ∀ r \\ {\sum }_{s ∈ stops ( r )} {\sum }_{o ∈ High ( r , s )} {k}_{o} {x}_{o , r} \leq {\sum }_{j ∈ Config ( r )} H {K}_{j , r} {η}_{j , r} & & ∀ r\end{matrix}$$

Bi-Temp Compartment Assignment

$${\sum }_{j ∈ Config ( r )} {η}_{j , r} \leq {\sum }_{t ∈ Trucks ( r )} {z}_{r , t} \qquad ∀ r$$

Bi-Temp Compartment Assignment 2

$${\sum }_{{j ∈ Config ( r ) ⋂}_{Compatible Configurations with type t \}}} {η}_{j , r} \geq {z}_{r , t} ∀ r , t$$

Bi-Temp Variable Domain
y_{r,s} ε {0,1} ∀r, s ε stops(r)
η_{j,r} ε {0,1} ∀r, j ε Config(r)
Driving Rules

An additional factor that may be taken into account in practicing the present invention is driving time. For example, drivers are often restricted in how long they can drive before they must rest. The DOT currently mandates 10 hours rest for every 11 hours of driving. This rule may be incorporated into a planned route by modifying the travel time between stops to add rest time wherever is it needed. To do that, total driving time may be tracked, with 10 hours of rest being added to a leg that goes over 11 hours. Considering that these times may change, they may be parameterized using the pseudo-code variables maxDrivingTime, maxDutyTime and restTime. The following pseudo code is provided as exemplary:

Initialize: A route with stops 1, 2..., n and travel times
between stops τ_{1,2},τ_{2,3},....,τ_{n-1,n}.
Let drivingTime=0. Let dutyTime= X_{r,s}.
Loop: For s=1 to n−1 Step+1

Let drivingTime:= drivingTime + τ_{s,s+1}
Let dutyTime:= drivingTime + X_{r,s}
If drivingTime >= maxDrivingTime Then

Let r= drivingTime Mod maxDrivingTime
Let n= (drivingTime − r ) / maxDrivingTime
Let τ_{s,s+1} = τ_{s,s+1} + restTime*n
Let drivingTime= r
Let dutyTime= r

Else

If dutyTime >= maxDutyTime Then

Let r0= dutyTime Mod maxDutyTime
Let n0=(dutyTime − r ) / maxDutyTime
Let τ_{s,s+1} = τ_{s,s+1} + restTime*n0
Let drivingTime= r0
Let dutyTime= r0

End If

End If
Next s

The modified travel times τ_{i,j} may thus be passed to the Bin-Pack model and used in optimization.

Inbound-Outbound Algorithm

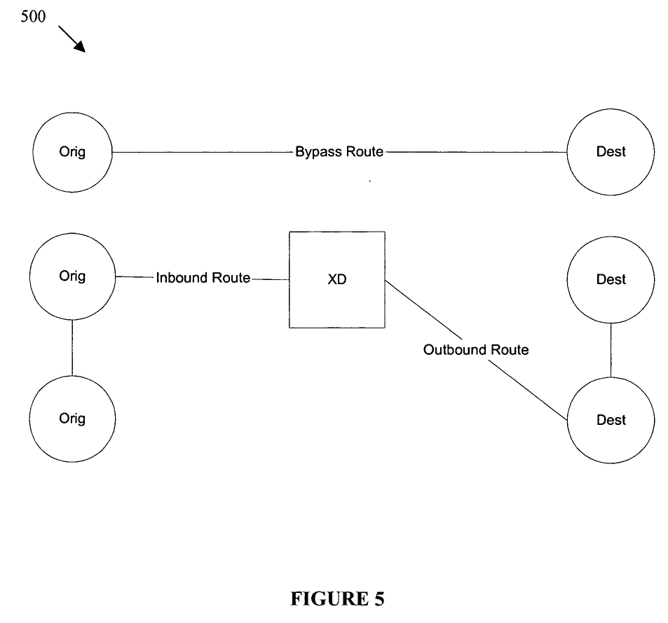

For at least the reason that numerous variations on the above-described embodiments are contemplated, an embodiment of the present invention that may be used to implement simultaneous inbound-outbound multi-stop routing through cross-docks and potentially additionally allowing by-pass routes, will now be described. Exemplary route types (Inbound, Outbound, Bypass) from origins (Orig), potentially through a Cross-Dock (XD) to Destinations (Dest) are shown in an overview illustration 500 in FIG. 5. This section is related to the route generation algorithm described above. While the above algorithm may be more suited to a problem of planning inbound delivery of goods, the following algorithm may be more suited to an inbound-outbound problem, depending on a particular implementation, desired results, etc., among other variables.

The following section describes an alternative process that may be implemented in accordance with the present invention to solve problems with specific transportation network types, or possible order routings. In such an embodiment, the network may consider some or all of the following types of order routing, or others:
Order routed by itself, direct from origin to destination.
Order routed by itself from origin to cross-dock, routed consolidated (single or multi-stop) to destination.
Routed consolidated from origin to cross-dock, order routed by itself to destination.
Order routed by itself from origin to cross-dock, order routed by itself to destination.
Routed consolidated from origin to cross-dock, routed consolidated to destination.
Routed consolidated from origin bypassing cross-docks to destination.
   Decisions that may be considered by this model include, but are not limited to:
Which routed consolidated routes are generated and used.
What is the best path (i.e. through a cross-dock or direct) for each order.
Which is the best cross-dock for each order considering inbound cost, labor cost and outbound cost.
Level of usage at cross-docks.
Others.
   Phases of the Algorithm

In one embodiment, the Inbound-Outbound algorithm is implemented in three phases, which again may in certain aspects be analogous or similar to those described above with respect to the generation algorithm above. Reference may therefore again be made to FIG. 2.

If an element of simplification is desired in accordance with an aspect of the present invention, order aggregation by OD pair and cross-dock capacity aggregation may be accomplished in this embodiment in a manner comparable to that described above, among others. Reference may therefore be made to any or all associated aggregations described herein, and/or others apparent to one skilled in the art upon consideration of the present disclosure.

In accordance with an embodiment of the invention, an acceptable way to formulate the LP for this phase will now be described. The solution to this LP may be route skeletons that may be used as input to the subsequent bin-pack phase. As in the inbound embodiment, this phase may use an aggregated, strategic approach intended to quickly find a route skeleton solution to the problem. Even though order volumes may be aggregated in this phase, the business rules may be modeled in this LP using the mathematical constraints listed below, among countless other possibilities and/or variations.

Variable Domain
zᵣ≧0 ∀r ε {Inbound routes}
z′_{r′}≧0 ∀r′ε {Outbound routes}
zd_{rd}≧0 ∀rd ∀ {Bypass routes}
x_{od,r}≧0 ∀od, ∀r ε {Inbound routes}∪{Bypass routes}
iltl_{od,cp}≧0 ∀od, ∀cp ε {Cross-Docks}
oltl_{od,cp}≧0 ∀od, ∀cp ε {Cross-Docks}
ltl_{od}≧0 ∀od
Variable and Parameter Definition

zᵣ is how many times rout r is selected. Solution Output.

z′_{r′} is one if outbound route r′ is selected. Solution Output.

zd_{rd} is one if bypass route rd is selected. Solution Output.

x_{od,r} is the proportion of od pair sent routed consolidated from its origin in route r. Solution Output.

y_{od,r′} is the proportion of od pair sent routed consolidated from the center-point in route r′. Solution Output.

xd_{od,rd} is the proportion of od pair sent routed consolidated in by-pass route rd. Solution Output.

iltl_{od,cp} is the proportion of od pair that travels routed by itself from its origin to cross-dock cp. Solution Output.

oltl_{od,cp} is the proportion of od pair that travels routed by itself from cross-dock cp to its destination. Solution Output.

ltl_{od} is the proportion of od par that travels routed by itself from its origin to its destination. Solution Output.

h_{od,r} handling cost of od pair traveling in route r. This value depends of the type route and where it finish. Input Parameter.

cᵣ,c′_{r′},cd_{rd} are respectively the transit costs for inbound route r, outbound route r′ and bypass route rd. Calculated during route generation.

ip_{od,cp} is the penalty of sending od pair routed by itself from its origin to center-point cp. Input parameter.

op_{od,cp} is the penalty of sending od pair routed by itself) from center-point cp to its destination. Input parameter.

p_{od} is the penalty of sending od pair routed by itself from its origin to its final destination. Input parameter.

V_{od} aggregated volume of od pair. Input parameter.

W_{od} aggregated weight of od pair. Input parameter.

TV volume capacity of the representative vehicle used in route r. Input parameter.

TW weight capacity of the representative vehicle used in route r. Input parameter.

C_{cp} it's the maximum aggregated throughput capacity of cross-dock cp. Input parameter.

MC_{cp} it's the minimum aggregated throughput capacity of cross-dock cp. Input parameter.

δ_{cp,r} is one if route r finishes at cross-dock cp. Generated Input.

ω_{od} is the size factor of pair od in route r, computed as:

$${ω}_{od} = max [ Ceil ( \frac{{V}_{od}}{TV} ) , Ceil ( \frac{{W}_{od}}{TW} ) ]$$

ε route factor appox. 0.001. Input.

$$min {\sum }_{od} {\sum }_{r ∈ \{ Inbound routes \}} {h}_{od , r} {x}_{od , r} + {\sum }_{r ∈ \{ Inbound routes \}} {c}_{r} {z}_{r} + {\sum }_{{r}^{′} ∈ \{ Outbound routes \}} {c}_{{r}^{′}}^{′} {z}_{{r}^{′}}^{′} + {\sum }_{r d ∈ \{ Bypass routes \}} c {d}_{r d} z {d}_{r d} + {\sum }_{od} {\sum }_{cp ∈ \{ Cross \text{-} Docks \}} i {p}_{od , cp} i l t {l}_{od , cp} + {\sum }_{od} {\sum }_{cp ∈ \{ Cross \text{-} Docks \}} o {p}_{od , cp} o l t {l}_{od , cp} + {\sum }_{od} {p}_{od} l t {l}_{od}$$

Cross-Dock Period Capacity (the number of routes that can visit the cross-dock during a given period)

$${MC}_{cp} \leq {\sum }_{r ∈ \{ \begin{matrix}Inbound Routes \\ Through XD r\end{matrix} \}} {δ}_{cp , r} {z}_{r , t} \leq {C}_{cp} \qquad ∀ cp ,$$

Inbound Cover Constraints (all orders must be on an inbound route)

$$l t {l}_{od} + {\sum }_{cp ∈ \{ Cross \text{-} Docks \}} i l t {l}_{od , cp} + {\sum }_{r ∈ \{ Inbound routes \}} {x}_{od , r} + {\sum }_{r d ∈ \{ Bypass routes \}} x {d}_{od , r d} = 1$$

$$∀ od$$

Outbound Cover Constraints (all orders must be on an outbound routes)

$$l t {l}_{od} + {\sum }_{cp ∈ \{ Cross \text{-} Docks \}} o l t {l}_{od , cp} + {\sum }_{{r}^{′} ∈ \{ outbound routes \}} {y}_{od , {r}^{′}} + {\sum }_{r d ∈ \{ Bypass routes \}} x {d}_{od , r d} = 1$$

$$∀ od$$

Cross-dock continuity (all orders that are routed into a cross-dock must be routed out of the cross dock)

$$i l t {l}_{od , cp} + {\sum }_{r ∈ \{ inbound routes at cp \}} {x}_{od , r} = o l t {l}_{od , cp} + {\sum }_{{r}^{′} ∈ \{ outbound routes at cp \}} {y}_{od , r}$$

$$∀ od , ∀ cp ∈ \{ Cross \text{-} Docks \}$$

Inbound Volume

$${\sum }_{od} {V}_{od} {x}_{od , r} \leq TV {z}_{r} \qquad ∀ r$$

Inbound Weight

$${\sum }_{od} {W}_{od} {x}_{od , r} \leq TW {z}_{r} \qquad ∀ r$$

Outbound Volume

$${\sum }_{od} {V}_{od} {y}_{od , {r}^{′}} \leq TV {z}_{{r}^{′}}^{′} \qquad ∀ {r}^{′}$$

Outbound Weight

$${\sum }_{od} {W}_{od} {y}_{od , {r}^{′}} \leq TW {z}_{{r}^{′}}^{′} \qquad ∀ {r}^{′}$$

Bypass Route Volume

$${\sum }_{od} {V}_{od} x {d}_{od , r d} \leq TV z {d}_{r d} \qquad ∀ r d$$

Bypass Route Weight

$${\sum }_{od} {W}_{od} x {d}_{od , r d} \leq TW z {d}_{r d , t} \qquad ∀ r d$$

Inbound Location Tie (an implicit modeling constraint that may be applied to ensure that the model does not inadvertently assign more routes to trucks at a location than it has assigned to orders at that location)

$${\sum }_{od} {ω}_{od} {x}_{od , r} \geq ɛ {z}_{r} \qquad ∀ r , l \text{:} l ∈ stops ( r )$$

Outbound Location Tie (an implicit modeling constraint that may be used to ensure that the model does not inadvertently assign more routes to trucks at a location than it has assigned to orders at that location)

$${\sum }_{od} {ω}_{od} {y}_{od , {r}^{′}} \geq ɛ {z}_{{r}^{′}}^{′} \qquad ∀ {r}^{′} , l \text{:} l ∈ stops ( {r}^{′} )$$

Bypass Route Location Tie (an implicit modeling constraint that may be used to ensure that the model does not inadvertently assign more routes to trucks at a location than it has assigned to orders at that location)

$${\sum }_{od} {ω}_{od} x {d}_{od , r d} \geq ɛ z {d}_{r d} \qquad ∀ r d , l \text{:} l ∈ stops ( r d )$$

Lifting Constraints Inbound

$${\sum }_{od ∈ \{ \begin{matrix}od from \\ location l\end{matrix} \}} max [ Ceil ( \frac{{V}_{od}}{TV} ) , Ceil ( \frac{{W}_{od}}{TW} ) ] ( l t {l}_{od} + {\sum }_{cp ∈ \{ Cross \text{-} Docks \}} i l t {l}_{od , cp} ) + {\sum }_{r ∈ \{ \begin{matrix}Inbound routes \\ through l\end{matrix} \}} {z}_{r} + {\sum }_{r d ∈ \{ \begin{matrix}Bypass routes \\ through l\end{matrix} \}} z {d}_{r d} \geq max [ Ceil ( \frac{{\sum }_{od ∈ \{ od pairs through l \}} {V}_{od}}{TV} ) , Ceil ( \frac{{\sum }_{od ∈ \{ od pairs through l \}} {W}_{od}}{TW} ) ]$$

$$∀ l ∈ \{ Origin location \}$$

Lifting Constraints Outbound

$${\sum }_{od ∈ \{ \begin{matrix}od to \\ location l\end{matrix} \}} max [ Ceil ( \frac{{V}_{od}}{TV} ) , Ceil ( \frac{{W}_{od}}{TW} ) ] ( l t {l}_{od} + {\sum }_{cp ∈ \{ Cross \text{-} Docks \}} o l t {l}_{od , cp} ) + {\sum }_{r ∈ \{ \begin{matrix}Outbound routes \\ to l\end{matrix} \}} {y}_{r} + {\sum }_{r d ∈ \{ \begin{matrix}Bypass routes \\ to l\end{matrix} \}} z {d}_{r d} \geq max [ Ceil ( \frac{{\sum }_{od ∈ \{ od pairs to l \}} {V}_{od}}{TV} ) , Ceil ( \frac{{\sum }_{od ∈ \{ od pairs to l \}} {W}_{od}}{TW} ) ]$$

$$∀ l ∈ \{ Destination location \}$$

Route generation

Route generation may be done following the same algorithms described in the above section.
Inbound Route Generation: Use the results of x_{od,r}, zᵣ.
Outbound Route Generation: Use the results of y_{od,r′}, z′_{r′}.
Bypass Route Generation: Use the results of xd_{od,rd} zdᵣ

The final phase of this embodiment of the invention may then apply explicit order volumes in a bin-pack approach on order to explicitly assign orders to routes. The input to this phase will be the route skeletons obtained in the previous phase. At this point, many business rules are explicitly modeled using the constraints and variables listed below.

Variable Domain
z_{r,t} {0,1} ∀r ε {Inbound routes} t ε Trucks(r)
z′_{r′,t} ε {0,1} ∀r′ε {Outbound routes} t ε Trucks(r)
zd_{rd,t} ε {0,1} ∀rd ε {Bypass routes} t ε Trucks(r)
x_{o,r} ε {0,1} ∀o ε {orders}, ∀r ε {Inbound routes}∪{Bypass routes}
iltl_{o,cp} ε {0,1} ∀o ε {orders}, ∀cp ε {Cross-Docks}
oltl_{o,cp} ε {0,1} ∀o ε {orders}, ∀cp ε {Cross-Docks}
ltlₒ ε {0,1} ∀o ε {orders}
ta_{s,r} ε [0,\overline{T}] ∀r ε {All routes}, ∀s ε stops(r)
td_{s,r} ε [0,\overline{T}] ∀r ε {All routes}, ∀s ε stops(r)
u_{p,r,s} ε {0,1} ∀r ε {All routes}, ∀s ε stops(r), p ε P(r, s)
v_{p,r,s} ε {0,1} ∀r ε {All routes}, ∀s ε stops(r), p ε P(r, s)
tid_{o,cp} ε [0,\overline{T}] ∀o ε {orders}, ∀cp ε {Cross-Docks}
tia_{o,cp} ε [0,\overline{T}] ∀o ε {orders}, ∀cp ε {Cross-Docks}
tod_{o,cp} ε [0,\overline{T}] ∀o ε {orders}, ∀cp ε {Cross-Docks}
toa_{o,cp} ε [0,\overline{T}] ∀o ε {orders}, ∀cp ε {Cross-Docks}
Variable and Parameter Definition

z_{r,t} is one if inbound route r is selected using truck t, 0 otherwise. Solution Output.

z′_{r′,t} is one if outbound route r′ is selected using truck t, 0 otherwise. Solution Output.

zd_{rd,t} is one if bypass route rd is selected using truck t, 0 otherwise. Solution Output.

x_{o,r} is one if order o is sent routed consolidated from its origin in route r, 0 otherwise. Solution Output.

y_{o,r′} is one if order o is sent routed consolidated from the center-point in route r′, 0 otherwise. Solution Output.

xd_{o,rd} is one if order o is sent routed consolidated in by-pass route rd, 0 otherwise. Solution Output.

iltl_{o,cp} is one if order o travels routed by itself from its origin to cross-dock cp, 0 otherwise. Solution Output.

oltl_{o,cp} is one if order o travels routed by itself from cross-dock cp to its destination, 0 otherwise. Solution Output.

ltlₒ is one if order o travels routed by itself from its origin to its destination, 0 otherwise. Solution Output.

ta_{s,r} is the arrival time of route r to stop s. Solution Output.

td_{s,r} is the departure time of route r from stop s. Solution Output.

u_{p,r,s} is one if route r reaches stop s on period p. Solution Output.

v_{p,r,s} is one if route r reaches stop s on period p. Solution Output.

tid_{o,cp} is the time order o departs from the vendor to cross-dock cp when routed by itself. Solution Output.

tia_{o,cp} is the time order o arrives to cross-dock cp when routed by itself. Solution Output.

tod_{o,cp} is the time order o leaves from cross-dock cp when routed by itself. Solution Output.

toa_{o,cp} is the time order o arrives to its final destination from cross-dock cp when routed by itself. Solution output.

h_{o,r} handling cost of order o traveling in route r. This value depends of the type route and where it finish. Input Parameter.

cᵣ,c′_{r′},cd_{rd} are respectively the transit costs for inbound route r, outbound route r′ and bypass route rd. Calculated during route generation.

ip_{o,cp} cost of sending order o routed by itself from its origin to center-point cp. Input parameter.

op_{o,cp} cost of sending order o routed by itself from center-point cp to its destination. Input parameter.

pₒ cost of sending order o routed by itself from its origin to its final destination. Input parameter.

Vₒ volume of order o. Input parameter.

Wₒ weight of order o. Input parameter.

TVᵣ volume capacity of the representative vehicle used in route r. Input parameter.

TWᵣ weight capacity of the representative vehicle used in route r. Input parameter.

HT_{o,cp} handing time required for order o at center-point cp. Input parameter.

\overline{T} length of the planning horizon. Preprocessed input.

θₒ loading time of order o. Input parameter.

θ unloading time of order o. Input parameter.

τ_{s,s′} travel time between location s and location s′. Input parameter.

aₒ earliest pick-up time for order o. Input parameter.

bₒ latest delivery time for order o. Input parameter.

C_{p,cp} it's the maximum throughput capacity of cross-dock cp during period p. Input parameter.

MC_{p,cp} it's the minimum throughput capacity of cross-dock cp during period p. Input parameter.

δ_{cp,r} is one if route r finishes at cross-dock cp. Generated Input.

WTₛ maximum waiting time before stop s. Input parameter.

Objective Function

Depending on an embodiment or particular implementation of the invention, an objective or objectives of this phase of the invention may be to minimize the cost of routing and/or handling of orders, while potentially also simultaneously minimizing some of the business constraints related to timing in the problem.

$$min {\sum }_{o ∈ \{ orders \}} {\sum }_{r ∈ \{ Inbound routes \}} {h}_{o , r} {x}_{o , r} + {\sum }_{r ∈ \{ Inbound routes \}} {\sum }_{t ∈ Trucks ( r )} {c}_{r , t} {z}_{r , t} + {\sum }_{{r}^{′} ∈ \{ Outbound routes \}} {\sum }_{t ∈ Trucks \{ {r}^{′} \}} {c}_{{r}^{′} , t}^{′} {z}_{{r}^{′} , t}^{′} + {\sum }_{r d ∈ \{ Bypass routes \}} {\sum }_{t ∈ Trucks ( r d )} c {d}_{r d , t} z {d}_{r d , t} + {\sum }_{o ∈ \{ orders \}} {\sum }_{cp ∈ \{ Cross \text{-} Docks \}} {ip}_{o , cp} i l t {l}_{o , cp} + {\sum }_{o ∈ \{ orders \}} {\sum }_{cp ∈ \{ Cross \text{-} Docks \}} {op}_{o , cp} o l t {l}_{o , cp} + {\sum }_{o ∈ \{ orders \}} {p}_{o} l t {l}_{o} + Ω {\sum }_{r ∈ \{ All routes \}} {\sum }_{s ∈ stops ( r )} t {a}_{s , r} + {Ω}^{′} {\sum }_{r ∈ \{ All routes \}} {\sum }_{s ∈ stops ( r )} t {d}_{s , r} + Ω {\sum }_{o ∈ \{ orders \}} {\sum }_{cp ∈ \{ Cross \text{-} Docks \}} ( {tia}_{o , cp} + {toa}_{o , cp} ) + {Ω}^{′} {\sum }_{o ∈ \{ orders \}} {\sum }_{cp ∈ \{ Cross \text{-} Docks \}} ( {tid}_{o , cp} + {tod}_{o , cp} )$$

Cross-Dock Period Capacity (number of routes visiting cross-dock cannot exceed capacity for that period)

$${MC}_{p , cp} \leq {\sum }_{r ∈ \{ \begin{matrix}Inbound Routes \\ Through XDr\end{matrix} \}} {δ}_{cp , r} {u}_{p , r , s} \leq {C}_{p , cp} ∀ cp , p$$

Route-Vehicle Assignment Inbound

$${\sum }_{t ∈ Trucks ( r )} {z}_{r , t} \leq 1 ∀ r$$

Route-Vehicle Assignment Outbound

$${\sum }_{t ∈ Trucks ( {r}^{′} )} {z}_{{r}^{′} , t}^{′} \leq 1 ∀ {r}^{′}$$

Route-Vehicle Assignment Bypass

$${\sum }_{t ∈ Trucks ( rd )} {zd}_{rd , t} \leq 1 ∀ rd$$

Inbound Bin-Pack Lifting

$${ltl}_{o} + {\sum }_{cp ∈ \{ Cross \text{-} Docks \}} {iltl}_{o , cp} + {\sum }_{r ∈ \{ \begin{matrix}inbound routes stoping at \\ location of order o\end{matrix} \}} {\sum }_{t ∈ Trucks ( r )} {z}_{r , t} + {\sum }_{rd ∈ \{ \begin{matrix}Bypass routes stopping \\ at location of order o\end{matrix} \}} {\sum }_{t ∈ Trucks ( rd )} {zd}_{rd , t} \geq 1$$

Outbound Bin-pack Lifting

$${ltl}_{o} + {\sum }_{cp ∈ \{ Cross \text{-} Docks \}} {oltl}_{o , cp} + {\sum }_{{r}^{′} ∈ \{ \begin{matrix}outbound routes stoping at \\ location of order o\end{matrix} \}} {\sum }_{t ∈ Trucks ( {r}^{′} )} {z}_{{r}^{′} , t} + {\sum }_{rd ∈ \{ \begin{matrix}Bypass routes delivering \\ at location of order o\end{matrix} \}} {\sum }_{t ∈ Trucks ( rd )} {zd}_{rd , t} \geq 1$$

Inbound Cover Constraints (all orders may be required to be routed inbound)

$$\begin{matrix}{ltl}_{o} + {\sum }_{cp ∈ \{ Cross \text{-} docks \}} {iltl}_{o , cp} + \\ {\sum }_{r ∈ \{ inbound routes \}} {x}_{o , r} + {\sum }_{rd ∈ \{ Bypass routes \}} {xd}_{o , rd}\end{matrix} = 1 ∀ o ∈ \{ orders \}$$

Outbound Cover Constraints (all orders may be required to be routed outbound)

$$\begin{matrix}{ltl}_{o} + {\sum }_{cp ∈ \{ Cross \text{-} docks \}} {oltl}_{o , cp} + \\ {\sum }_{{r}^{′} ∈ \{ outbound routes \}} {y}_{o , {r}^{′}} + {\sum }_{rd ∈ \{ Bypass routes \}} {xd}_{o , rd}\end{matrix} = 1 ∀ o ∈ \{ orders \}$$

Cross-dock continuity (all orders routed into a cross-dock may be required to be routed out of the cross-dock)

$${iltl}_{o , cp} + {\sum }_{r ∈ \{ inbound routes at cp \}} {x}_{o , r} = {oltl}_{o , cp} + {\sum }_{{r}^{′} ∈ \{ outbound routes at cp \}} {y}_{o , r} ∀ o ∈ \{ orders \} , ∀ cp ∈ \{ Cross \text{-} Docks \}$$

Inbound Volume

$${\sum }_{o ∈ \{ \begin{matrix}Orders at locations \\ visited by route ⋯ r\end{matrix} \}} {V}_{o} {x}_{o , r} \leq {\sum }_{t ∈ Trucks ( t )} {TV}_{t} {z}_{r , t} ∀ r$$

Inbound Weight

$${\sum }_{o ∈ \{ \begin{matrix}Orders at locations \\ visited by route ⋯ r\end{matrix} \}} {W}_{o} {x}_{o , r} \leq {\sum }_{t ∈ Trucks ( r )} T {W}_{t} {z}_{r , t} \qquad ∀ r$$

Outbound Volume

$${\sum }_{o ∈ \{ \begin{matrix}Orders at locations \\ visited by route ⋯ {r}^{′}\end{matrix} \}} {V}_{o} {y}_{o , {r}^{′}} \leq {\sum }_{t ∈ Trucks ( {r}^{′} )} T {V}_{t} {z}_{{r}^{′} , t}^{′} \qquad ∀ {r}^{′}$$

Outbound Weight

$${\sum }_{o ∈ \{ \begin{matrix}Orders at locations \\ visited by route ⋯ {r}^{′}\end{matrix} \}} {W}_{o} {y}_{o , {r}^{′}} \leq {\sum }_{t ∈ Trucks ( {r}^{′} )} T {W}_{r} {z}_{{r}^{′} , t}^{′} \qquad ∀ {r}^{′}$$

Bypass Route Volume

$${\sum }_{o ∈ \{ \begin{matrix}Orders for pick \text{-} up at \\ locations visited by route r d\end{matrix} \}} {V}_{o} x {d}_{o , r d} \leq {\sum }_{t ∈ Trucks ( r d )} T {V}_{r d} z {d}_{r d , t} \qquad ∀ r d$$

Bypass Route Weight

$${\sum }_{o ∈ \{ \begin{matrix}Orders for pick \text{-} up at \\ locations visited by route r d\end{matrix} \}} {W}_{o} x {d}_{o , r d} \leq {\sum }_{t ∈ Trucks ( r d )} T {W}_{r d} z {d}_{r d , t} \qquad ∀ r d$$

Inbound Location Tie (an implicit modeling constraint that may be applied to ensure that the model does not inadvertently assign more routes to trucks at a location than it has assigned to orders at that location)

$${\sum }_{o ∈ O ( r , l )} {x}_{o , r} \geq {\sum }_{t ∈ Trucks ( r )} {z}_{r , t} \qquad ∀ r , l \text{:} l ∈ stops ( r )$$

Outbound Location Tie (an implicit modeling constraint that may be applied to ensure that the model does not inadvertently assign more routes to trucks at a location than it has assigned to orders at that location)

$${\sum }_{o ∈ O ( r , l )} {y}_{o , {r}^{′}} \geq {\sum }_{t ∈ Trucks ( {r}^{′} )} {z}_{{r}^{′} , t}^{′} \qquad ∀ {r}^{′} , l \text{:} l ∈ stops ( {r}^{′} )$$

Bypass Route Location Tie (an implicit modeling constraint that may be applied to ensure that the model does not inadvertently assign more routes to trucks at a location than it has assigned to orders at that location)

$${\sum }_{o ∈ O ( r d , l )} x {d}_{o , r d} \geq {\sum }_{t ∈ Trucks ( r d )} z {d}_{r d , t} \qquad ∀ r d , l \text{:} l ∈ stops ( r d )$$

Cross-Dock Time Feasibility (may be applied to ensure that orders traveling through a cross dock will be able to meet their timing constraints and requirements)
ta_{cp,r}+HT_{o,cp}(x_{o,r}+y_{o,r′}−1)≦td_{cp,r′}+2\overline{T}(1−x_{o,r})+2\overline{T}(1−y_{o,r′}) ∀o, cp, r ε R(o), r′ε R′(o)
Cross-Dock Time Feasibility Inbound Order Routed by Itself
tia_{o,cp}+HT_{o,cp}(iltl_{o,cp}+y_{o,r′}−1)≦td_{cp,r′}+2\overline{T}(1−iltl_{o,cp})+2\overline{T}(1−y_{o,r′}) ∀o, cp, r′ε R′(o)
Cross-Dock Time Feasibility Outbound Order Routed by Itself
ta_{cp,r}+HT_{o,cp}(x_{o,r}+oltl_{o,cp}−1)≦tod_{o,cp}+2\overline{T}(1−x_{o,r})+2\overline{T}(1−oltl_{o,cp}) ∀o, cp, r ε R(o)
Inbound Loading Time Constraints

$$t {a}_{s , r} + {\sum }_{o ∈ O ( r , s )} {θ}_{o} {x}_{o , r} \leq t {d}_{s , r} \qquad ∀ r , s \text{:} s ∈ stops ( r )$$

Outbound Unloading Time Constraints

$$\begin{matrix}t {a}_{{s}^{′} , {r}^{′}} + {\sum }_{o ∈ \{ orders delivered at {s}^{′} \}} {ϑ}_{o} {y}_{o , {r}^{′}} \leq t {d}_{{s}^{′} , {r}^{′}} \\ ∀ {r}^{′} , {s}^{′} \text{:} {s}^{′} ∈ delivery stops ( {r}^{′} )\end{matrix}$$

Inbound Travel Time Constraints
td_{s,r}+τ_{s,s+1}zᵣ≦ta_{s+1,r} ∀r, s:s ε stops(r)
Outbound Travel Time Constraints
td_{s′,r′}+τ_{s′,s′+1}z′_{r′}≦ta_{s′+1,r′} ∀r′, s′:s′ε stops(r′)
Inbound Pick-Up Start Time Constraint
td_{s,r}≧(aₒ+θₒ)x_{o,r} ∀r, s:s ε stops(r) oε Orders(s)
Inbound Pick-Up End Time Constraint
ta_{s,r}≦bₒx_{o,r}+\overline{T}(1−x_{o,r}) ∀r, s:s ε stops(r) o ε Orders(s)
Outbound Delivery Time Constraint
ta_{s*,r′}≦b′ₒy_{o,r′}+\overline{T}(1−y_{o,r′}) ∀r′, s′=LastStop(r′) o ε Orders(s′)
Inbound Loading Time Constraints

$${ta}_{s , r} + {\sum }_{o ∈ O ( r , s )} {θ}_{o} {x}_{o , r} \leq {td}_{s , r} \qquad ∀ r , s \text{:} s ∈ stops ( r )$$

Outbound Unloading Time Constraints

$$\begin{matrix}{ta}_{{s}^{′} , {r}^{′}} + {\sum }_{o ∈ \{ orders delivered at {s}^{′} \}} {ϑ}_{o} {y}_{o , {r}^{′}} \leq {td}_{{s}^{′} , {r}^{′}} \\ ∀ {r}^{′} , {s}^{′} \text{:} {s}^{′} ∈ delivery stops ( {r}^{′} )\end{matrix}$$

Bypass Loading Time Constraints

$${ta}_{s , r d} + {\sum }_{o ∈ O ( r d , s )} {θ}_{o} {x}_{o , r d} \leq {td}_{s , r d} \qquad ∀ r d , s \text{:} s ∈ stops ( r d )$$

Bypass Unloading Time Constraints

$$\begin{matrix}{ta}_{s , r d} + {\sum }_{o ∈ \{ orders delivered at s \}} {ϑ}_{o} {y}_{o , r d} \leq {td}_{s , r d} \\ ∀ r d , s \text{:} s ∈ delivery stops ( r d )\end{matrix}$$

Stop-Time arrival period cover (may be used to ensure that for each arrival time period defined, the model assigns the appropriate number of trucks)

$$\begin{matrix}{\sum }_{p ∈ P ( s , r )} {u}_{p , s , r} = {\sum }_{t ∈ Trucks ( r )} {z}_{r , t} \\ ∀ r ∈ \{ Inbound routes \} ⋃ \{ Outbound routes \} ⋃ \{ Bypass routes \} , \\ s ∈ stops ( r )\end{matrix}$$

Stop departure period cover (may be used to ensure that for each departure time period defined, the model assigns the appropriate number of trucks)

$$\begin{matrix}{\sum }_{p ∈ P ( s , r )} {v}_{p , s , r} = {\sum }_{t ∈ Trucks ( r )} {z}_{r , t} \\ ∀ r ∈ \{ Inbound routes \} ⋃ \{ Outbound routes \} ⋃ \{ Bypass routes \} , \\ s ∈ stops ( r )\end{matrix}$$

Stop Arrival Time Window
α_{p,r,s}u_{p,r,s}≦ta_{s,r}≦β_{p,r,s}u_{p,r,s}+\overline{T}(1−u_{p,r,s})

∀r ε {Inbound routes}∪{Outbound routes}∪{Bypass routes}, s ε stops(r), p ε P(r, s)

Stop departure time window
α_{p,r,s}v_{p,r,s}≦ta_{s,r}≦β_{p,r,s}v_{p,r,s}+\overline{T}(1−v_{p,r,s})
∀r ε {Inbound routes}∪{Outbound routes}∪{Bypass routes}, s ε stops(r), p ε P(r, s)
Waiting Time Before a Stop—Inbound Routes

$$\begin{matrix}{ta}_{s + 1 , r} - {td}_{s , r} - {τ}_{s , s + 1} {\sum }_{t ∈ Trucks ( r )} {z}_{r , t} \leq {WT}_{s + 1} {\sum }_{t ∈ Trucks ( r )} {z}_{r , t} + \overline{T} ( 1 - {\sum }_{t ∈ Trucks ( r )} {z}_{r , t} ) \\ ∀ r , s ∈ stops ( r )\end{matrix}$$

Waiting Time Before a Stop—Outbound Routes

$${ta}_{s + 1 , {r}^{′}} - {td}_{s , {r}^{′}} - {τ}_{s , s + 1} {\sum }_{t ∈ Trucks ( {r}^{′} )} {z}_{{r}^{′} , t}^{′} \leq {WT}_{s + 1} {\sum }_{t ∈ Trucks ( {r}^{′} )} {z}_{{r}^{′} , t}^{′} + \overline{T} ( 1 - {\sum }_{t ∈ Trucks ( {r}^{′} )} {z}_{{r}^{′} , t}^{′} )$$

$$∀ {r}^{′} , s ∈ stops ( {r}^{′} )$$

Waiting Time Before a Stop—By-Pass Routes

$${ta}_{s + 1 , r d} - {td}_{s , r d} - {τ}_{s , s + 1} {\sum }_{t ∈ Trucks ( r d )} {zd}_{r d , t} \leq {WT}_{s + 1} {\sum }_{t ∈ Trucks ( r d )} {zd}_{r d , t} + \overline{T} ( 1 - {\sum }_{t ∈ Trucks ( r d )} {zd}_{r d , t} )$$

$$∀ r d , s ∈ stops ( r d )$$

In accordance with the above description and discussions, the present invention may enable one who practices it to quickly solve shipping or related problems of large sizes without having to sacrifice a quality of a result. It should be noted that, as discussed above, the methods disclosed herein in accordance with the invention need not include all disclosed steps or necessarily be practiced in a described order. For example, various constraints and related features of the above processes are exemplary, and solutions may be obtained in accordance with the invention through the use of a portion of the disclosed features, variations thereon, or others. In addition, it is contemplated that various method steps disclosed in one example or embodiment may be combined with one or more other steps in one or more other examples or embodiments, to achieve a method in accordance with the invention. For these and other reasons, the inventions disclosed should not be limited to embodiments presented herein, but rather are defined more generally, as by the appended claims.

1. A method for shipment planning optimization, comprising:
providing a master optimization program;
relaxing parameters of the master optimization program;
establishing additional parameters for the master optimization program;
generating routes based on the relaxed parameters and the additional parameters;
adding lifting inequalities to the master optimization program to provide further relaxation;
creating route skeletons based on a result of the master optimization program following the adding of the lifting inequalities; and
developing a shipment planning optimization solution based at least in part on the route skeletons.

2. A system for generating planned routes, comprising:
initialization means for providing initialization information comprising a set of potential combinations of variables associated with the routes to be planned;
generation means for generating and optimizing potential routes based on the initialization information;
integer program means for determining an optimal value for at least one of the variables associated with the routes to be planned; and
bin-pack means for determining a partition assignment of the at least one of the variables associated with the routes to be planned, such that an objective function associated with the routes to be planned is minimized or maximized.

3. The system of claim 2, wherein said generation means includes means for solving a linear programming problem.
